(19) United States
(12) Patent Application Publication
(10) Pub. No.: US 2011/0240699 A1
(43) Pub. Date: Oct. 6, 2011

(54) STICK ATTACHMENT FOR AN ALL TERRAIN VEHICLE

(76) Inventor: RUSH STACY, Hatfield, KY (US)

(21) Appl. No.: 12/750,497

(22) Filed: Mar. 30, 2010

(51) Int. Cl. B60R 11/00

(52) U.S. Cl. 224/488

(57) ABSTRACT

The present invention relates to an attachment device to disperse spider webbing in the path of an all terrain vehicle (ATV) comprising: a bracket assembly, where said bracket assembly includes a top bracket and a bottom bracket; a plurality of bolts, where said plurality of bolts provide a means for attaching the bracket assembly to the ATV; a stick, where the stick includes a mounting screw at one end thereof; and an insert on the top bracket, where the insert receives the mounting screw to mount the stick to the top bracket. The stick may include a rubber tip at the opposite end of the stick. In one exemplary embodiment, the stick includes a series of lights along the length thereof and a power connection.

### BACKGROUND OF THE INVENTION

1. Field of Invention

The following invention relates to an attachment device for an all terrain vehicle that helps to disperse of spider webs while traveling on the all terrain vehicle.

2. Description of Related Art

An all terrain vehicle is a three to four-wheel vehicle that is used for recreation and enjoyment in most instances. Many all terrain vehicles are not legal vehicles for use on the roadways and as the name suggests are used for travel over various terrains. The all terrain vehicle operates similarly to a motorcycle where an individual straddles a seat and controls the movement of the vehicle through the use of handlebars. Although the all terrain vehicle is operated similar to a motorcycle it normally has three to four wheels as opposed to the two-wheel motorcycle. All terrain vehicles are occasionally used for hunting and in some instances for racing purposes. Many times individuals operate all terrain vehicles through wooded areas or fields. Most all terrain vehicles do not include a windshield and therefore the operator may be exposed to debris, branches and in some instances spider webs that may be in the line of travel through the woods. Spider webs may create an irritating nuisance for ATV operators because of the potential for spider bites that may be incurred due to traveling through a spider web. Further, the spider webs increase the chance of accidents or other bodily injury because the operator must wipe the webbing from their face or goggles in order to continue operating the vehicle. Consequently, it would be advantageous to have a device that could disperse of or break through webbing prior to coming in contact with the driver or the ATV. Such a device would be useful in avoiding spider webs and spiders that may habitant them.

### SUMMARY OF THE INVENTION

The present invention relates to an attachment device to disperse spider webbing in the path of an all terrain vehicle (ATV) comprising: a bracket assembly, where said bracket assembly includes a top bracket and a bottom bracket; a plurality of bolts, where said plurality of bolts provide a means for attaching the bracket assembly to the ATV; a stick, where the stick includes a mounting screw at one end thereof; and an insert on the top bracket, where the insert receives the mounting screw to mount the stick to the top bracket. The stick may include a rubber tip at the opposite end of the stick. In one exemplary embodiment, the stick includes a series of lights along the length thereof and a power connection.

### BRIEF DESCRIPTION OF DRAWINGS

FIG. 1A depicts spider stick attachment for an ATV according to the present invention.

FIG. 1B depicts an alternative spider stick attachment according to the present invention.

FIG. 2 depicts an attachment bracket that is used to attach a spider stick to an ATV vehicle.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

The present invention provides a stick attachment that is secured onto a ATV in order to remove spider webs in the pathway of a ATV. The present invention includes a mounting bracket that supports the stick attachment once it is secured onto the ATV. The attachment bracket may be attached to the front rack of the ATV and supports the stick in a vertical position. This assists in the removal or breaking up of a web that may be in the line of travel of an ATV.

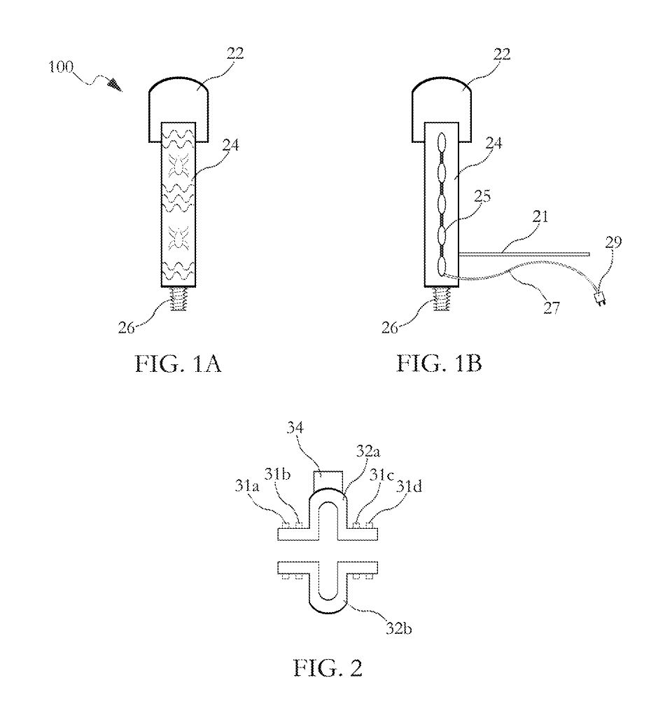

One exemplary embodiment of the spider stick according to the present invention is depicted in FIG. 1A. The spider stick 100 is attached to the ATV as a means to breakup a spider web. The spider stick 100 includes a rubber tip 22 on top of a stick body 24. A mounting screw 26 is provided at the opposite end of the stick body 24. The stick 100 may be mounted upon the front rack of an ATV and provides a means to disperse or eliminate a spider web before it comes in contact with the operator of the ATV. FIG. 2 depicts the mounting bracket used to mount the stick 100 onto an ATV. The mounting bracket includes a top bracket 32a and bottom bracket 32b. These brackets are secured onto the front rack of an ATV by using bolts 32a, 32b, 32c, 32d. An oval opening is provided between the brackets for the insertion of the front rack. The top bracket 32a includes an insert 34 that allows for the insertion of the mounting screw 26. Once the brackets are secured onto the ATV, the stick 100 is screwed into the insert 34 and locked into place for use.

FIG. 1B provides an alternative embodiment of the stick 100. The alternative embodiment, in addition to the elements of the embodiment shown in FIG. 1A, includes a series of lights 25 that extend along the length of the stick body 24. The lights 25 are powered through a plug insert that plugs into a power outlet provided on the ATV. A power cord 27 extends from the bottom of the series lights 25 and has a power plug 29 at the end thereof. Also provided on this alternative embodiment is a wire 21 that may be placed between two sticks that are mounted on the ATV. It is contemplated in another embodiment at the present invention, two sticks are mounted on each side of the front rack of the ATV and a wire is stretched between the sticks. The use of two sticks provides a larger breadth or width of coverage for potential spider webs that may be encountered while traveling on the ATV.

The present invention helps to eliminate contact with spider webs that may exist in the woods and could come into the pathway of an ATV while being operated. This avoids the driver having to deal with the cumbersome webs and potential spider bits that may be encountered if the stick according to the present invention was not installed. Use of the spider stick according to present invention helps to prevent injuries and is an easily attachment that may be provided for an ATV. The instant invention has been shown and described in what it considers to be the most practical and preferred embodiments. It is recognized, however, that departures may be made there from within the scope of the invention and that obvious modifications will occur to a person skilled in the art.

What is claimed is:

1. An attachment device to disperse spider webbing in the path of an all terrain vehicle (ATV) comprising:
a. a bracket assembly, where said bracket assembly includes a top bracket and a bottom bracket;
b. a plurality of bolts, where said plurality of bolts provide a means for attaching the bracket assembly to the ATV;
c. a stick, where the stick includes a mounting screw at one end thereof; and
d. an insert on the top bracket, where the insert receives the mounting screw to mount the stick to the bracket.

2. The attachment device according to claim 1, where said stick include a rubber tip.

3. The attachment device according to claim 1, where the stick includes a series of lights along the length thereof and a power connection.

4. The attachment device according to claim 1, where four bolts are used to attach the bracket assembly.
